(19) United States
(12) Patent Application Publication
(10) Pub. No.: US 2012/0254501 A1
(43) Pub. Date: Oct. 4, 2012

(54) SYSTEM ARCHITECTURE BASED ON FLASH MEMORY

(76) Inventors: Byungcheol Cho, Seochogu (KR); Moon J. Kim, Wappingers Falls, NY (US)

(21) Appl. No.: 13/073,006

(22) Filed: Mar. 28, 2011

(51) Int. Cl. G06F 12/00

(52) U.S. Cl. 711/103; 711/E12.008

(57) ABSTRACT

Embodiments of the present invention provide a semiconductor storage device (SSD) system architecture based on flash memory. Specifically, embodiments of this invention provide a set of SSD RAID controllers coupled to a system control board. A set of flash memory control units coupled to each of the set of SSD RAID controllers, each of the set of flash memory control units comprising an SSD controller and a set of flash memory units.

### CROSS-REFERENCE TO RELATED APPLICATION

This application is related in some aspects to commonly-owned, co-pending application Ser. No. 12/758,937, entitled SEMICONDUCTOR STORAGE DEVICE”, filed on Apr. 13, 2010, the entire contents of which are herein incorporated by reference.

### FIELD OF THE INVENTION

The present invention relates to a semiconductor storage device (SSD) system architecture based on flash memory.

### BACKGROUND OF THE INVENTION

As the need for more computer storage grows, more efficient solutions are being sought. As is known, there are various hard disk solutions that store/read data in a mechanical manner as a data storage medium. Unfortunately, data processing speed associated with hard disks is often slow. Moreover, existing solutions still use interfaces that cannot catch up with the data processing speed of memory disks having high-speed data input/output performance as an interface between the data storage medium and the host. Therefore, there is a problem in the existing area in that the performance of the memory disk cannot be property utilized.

### SUMMARY OF THE INVENTION

Embodiments of the present invention provide a semiconductor storage device (SSD) system architecture based on flash memory. Specifically, embodiments of this invention provide a set of SSD RAID controllers coupled to a system control board. A set of flash memory control units coupled to each of the set of SSD RAID controllers, each of the set of flash memory control units comprising an SSD controller and a set of flash memory units.

A first aspect of the present invention provides an SSD system architecture based on flash memory, comprising: a set of SSD RAID controllers coupled to a system control board; a fibre channel chip coupled to the system control board; and a set of flash memory control units coupled to each of the set of SSD RAID controllers, each of the set of flash memory control units comprising an SSD controller and a set of flash memory units.

A second aspect of the present invention provides a method for providing an SSD system architecture based on flash memory, comprising: coupling a set of SSD RAID controllers to a system control board; coupling a fibre channel chip to the system control board; and coupling a set of flash memory control units to each of the set of SSD RAID controllers, each of the set of flash memory control units comprising an SSD controller and a set of flash memory units.

A third aspect of the present invention provides an SSD system architecture based on flash memory, comprising: a chip; a processor coupled to the chip; a main RAID controller coupled to the chip; a set of SSD RAID controllers coupled to the main RAID controller; and a set of flash memory control units coupled to each of the set of SSD RAID controllers, each of the set of flash memory control units comprising an SSD controller and a set of flash memory units.

A fourth aspect of the present invention provides a method for providing an SSD system architecture based on flash memory, comprising: coupling a processor to a chip; coupling a main RAID controller to the chip; coupling a set of SSD RAID controllers to the main RAID controller; and coupling a set of flash memory control units to each of the set of SSD RAID controllers, each of the set of flash memory control units comprising an SSD controller and a set of flash memory units.

A fifth aspect of the present invention provides an SSD multi-RAID system architecture based on flash memory, comprising: a main RAID controller coupled to a system control board; a set of flash memory RAID subcontrollers coupled to the main RAID controller; and a set of flash memory RAID control blocks coupled to each of the set of flash memory RAID subcontrollers, each of the set of flash memory RAID control blocks comprising a set of flash memory units.

A sixth aspect of the present invention provides an SSD multi-RAID system architecture based on flash memory, comprising: a main RAID controller coupled to a system control board; a set of flash memory RAID subcontrollers coupled to the main RAID controller; and a set of flash memory RAID control blocks coupled to each of the set of flash memory RAID subcontrollers, each of the set of flash memory RAID control blocks comprising a set of flash memory units and a PCI-Express RAID controller.

A seventh aspect of the present invention provides a method for providing an SSD multi-RAID system architecture based on flash memory, comprising: coupling a main RAID controller to a system control board; coupling a set of flash memory RAID subcontrollers to the main RAID controller; and coupling a set of flash memory RAID control blocks to each of the set of flash memory RAID subcontrollers, each of the set of flash memory RAID control blocks comprising a set of flash memory units.

### BRIEF DESCRIPTION OF THE DRAWINGS

These and other features of this invention will be more readily understood from the following detailed description of the various aspects of the invention taken in conjunction with the accompanying drawings in which:

FIG. 1 is a diagram schematically illustrating a configuration of a RAID controlled storage device of a PCI-Express (PCI-e) type according to an embodiment of the present invention.

FIG. 2 is a more specific diagram of a RAID controller coupled to a set of SSDs.

FIG. 3 is a diagram schematically illustrating a configuration of the high-speed SSD of FIG. 1.

FIG. 4 is a diagram schematically illustrating the SSD system based on flash memory.

FIG. 5 is an alternate diagram schematically illustrating the SSD system based on flash memory.

FIG. 6 is a flash memory block diagram illustrating the memory components.

FIG. 7 is a diagram schematically illustrating the flash unit architecture.

FIG. 8 is a diagram schematically illustrating an SSD multi-RAID system architecture based on flash memory.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

Exemplary embodiments now will be described more fully herein with reference to the accompanying drawings, in which exemplary embodiments are shown. This disclosure may, however, be embodied in many different forms and should not be construed as limited to the exemplary embodiments set forth therein. Rather, these exemplary embodiments are provided so that this disclosure will be thorough and complete and will fully convey the scope of this disclosure to those skilled in the art. In the description, details of well-known features and techniques may be omitted to avoid unnecessarily obscuring the presented embodiments.

The terminology used herein is for the purpose of describing particular embodiments only and is not intended to be limiting of this disclosure. As used herein, the singular forms “a”, “an”, and “the” are intended to include the plural forms as well, unless the context clearly indicates otherwise. Furthermore, the use of the terms “a”, “an”, etc. do not denote a limitation of quantity, but rather denote the presence of at least one of the referenced items. It will be further understood that the terms “comprises” and/or “comprising”, or “includes” and/or “including”, when used in this specification, specify the presence of stated features, regions, integers, steps, operations, elements, and/or components, but do not preclude the presence or addition of one or more other features, regions, integers, steps, operations, elements, components, and/or groups thereof. Moreover, as used herein, the term RAID means redundant array of independent disks (originally redundant array of inexpensive disks). In general, RAID technology is a way of storing the same data in different places (thus, redundantly) on multiple hard disks. By placing data on multiple disks, I/O (input/output) operations can overlap in a balanced way, improving performance. Since multiple disks increase the mean time between failures (MTBF), storing data redundantly also increases fault tolerance. The term SSD means semiconductor storage device. The term flash memory means double data rate. Still yet, the term HDD means hard disk drive.

Unless otherwise defined, all terms (including technical and scientific terms) used herein have the same meaning as commonly understood by one of ordinary skill in the art. It will be further understood that terms such as those defined in commonly used dictionaries should be interpreted as having a meaning that is consistent with their meaning in the context of the relevant art and the present disclosure, and will not be interpreted in an idealized or overly formal sense unless expressly so defined herein.

Hereinafter, a RAID storage device of an I/O standard such as a serial attached small computer system interface (SAS)/serial advanced technology attachment (SAIA) type according to an embodiment will be described in detail with reference to the accompanying drawings.

As indicated above, embodiments of the present invention provide a flash memory storage system for a multi-level RAID architecture. Specifically, embodiments of this invention provide a main RAID controller coupled to a system control board. Coupled to the main RAID controller is a set of flash memory RAID subcontrollers. A set of flash memory RAID control blocks is coupled to each of the set of flash memory RAID subcontrollers, each of the set of flash memory RAID control blocks include a set of flash memory units.

The storage device of an I/O standard such as a serial attached small computer system interface (SAS)/serial advanced technology attachment (SATA) type supports a low-speed data processing speed for a host by adjusting synchronization of a data signal transmitted/received between the host and a memory disk during data communications between the host and the memory disk through a PCI-Express interface, and simultaneously supports a high-speed data processing speed for the memory disk, thereby supporting the performance of the memory to enable high-speed data processing in an existing interface environment at the maximum. It is understood in advance that although PCI-Express technology will be utilized in a typical embodiment, other alternatives are possible. For example, the present invention could utilize SAS/SATA technology in which a SAS/SATA type storage device is provided that utilizes a SAS/SATA interface.

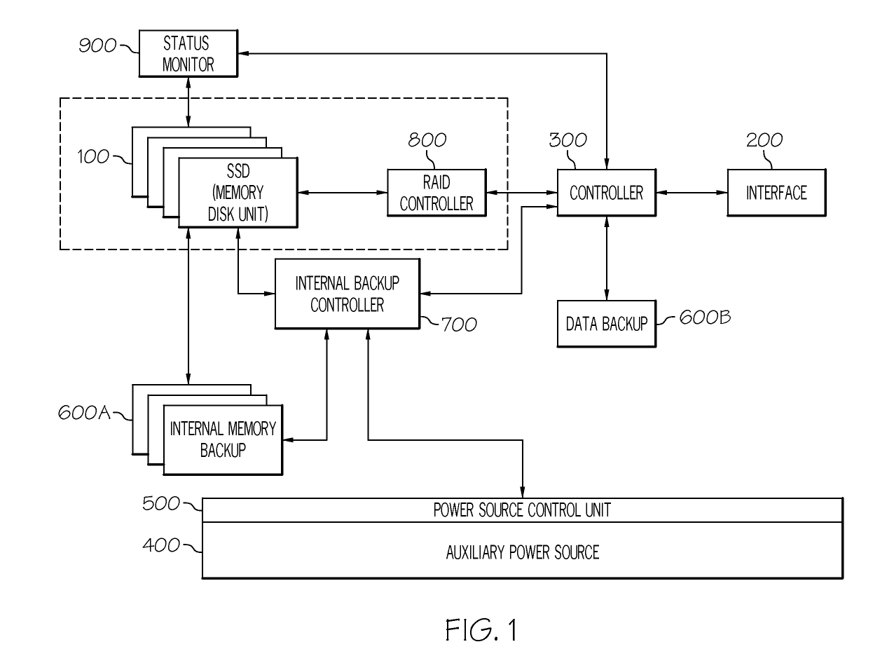

Referring now to FIG. 1, a diagram schematically illustrating a configuration of a PCI-Express type, RAID controlled storage device (e.g., for providing storage for a serially attached computer device) according to an embodiment of the invention is shown. As depicted, FIG. 1 shows a RAID controlled PCI-Express type storage device according to an embodiment of the invention which includes a memory disk unit 100 comprising: a plurality of memory disks having a plurality of volatile semiconductor memories (also referred to herein as high-speed SSDs 100); a RAID controller 800 coupled to SSDs 100; an interface unit 200 (e.g., PCI-Express host) which interfaces between the memory disk unit and a host; a controller unit 300; an auxiliary power source unit 400 that is charged to maintain a predetermined power using the power transferred from the host through the PCI-Express host interface unit; a power source control unit 500 that supplies the power transferred from the host through the PCI-Express host interface unit to the controller unit, the memory disk unit, the backup storage unit, and the backup control unit which, when the power transferred from the host through the PCI-Express host interface unit is blocked or an error occurs in the power transferred from the host, receives power from the auxiliary power source unit and supplies the power to the memory disk unit through the controller unit; a backup storage unit 600A-B that stores data of the memory disk unit; and a backup control unit 700 that backs up data stored in the memory disk unit in the backup storage unit, according to an instruction from the host or when an error occurs in the power transmitted from the host.

The memory disk unit 100 includes a plurality of memory disks provided with a plurality of volatile semiconductor memories for high-speed data input/output (for example, flash memory, flash memory2, flash memory3, SDRAM, and the like), and inputs and outputs data according to the control of the controller 300. The memory disk unit 100 may have a configuration in which the memory disks are arrayed in parallel.

The PCI-Express host interface unit 200 interfaces between a host and the memory disk unit 100. The host may be a computer system or the like, which is provided with a PCI-Express interface and a power source supply device.

The controller unit 300 adjusts synchronization of data signals transmitted/received between the PCI-Express host interface unit 200 and the memory disk unit 100 to control a data transmission/reception speed between the PCI-Express host interface unit 200 and the memory disk unit 100.

As depicted, a PCI-e type RAID controller 800 can be directly coupled to any quantity of SSDs 100. Among other things, this allows for optimum control of SSDs 100. Among other things, the use of a RAID controller 800:
1. Supports the current backup/restore operations.
2. Provides additional and improved backup function by performing the following:
   a) the internal backup controller determines the backup (user's request order or the status monitor detects power supply problems);
   b) the internal backup controller requests a data backup to SSDs;
   c) the internal backup controller requests internal backup device to backup data immediately;
   d) monitors the status of the backup for the SSDs and internal backup controller; and
   e) reports the internal backup controller's status and end-op.
3. Provides additional and improved restore function by performing the following:
   a) the internal backup controller determines the restore (user's request order or the status monitor detects power supply problems);
   b) the internal backup controller requests a data restore to the SSDs;
   c) the internal backup controller requests internal backup device to restore data immediately;
   d) monitors the status of the restore for the SSDs and internal backup controller; and
   e) reports the internal backup controller status and end-op.

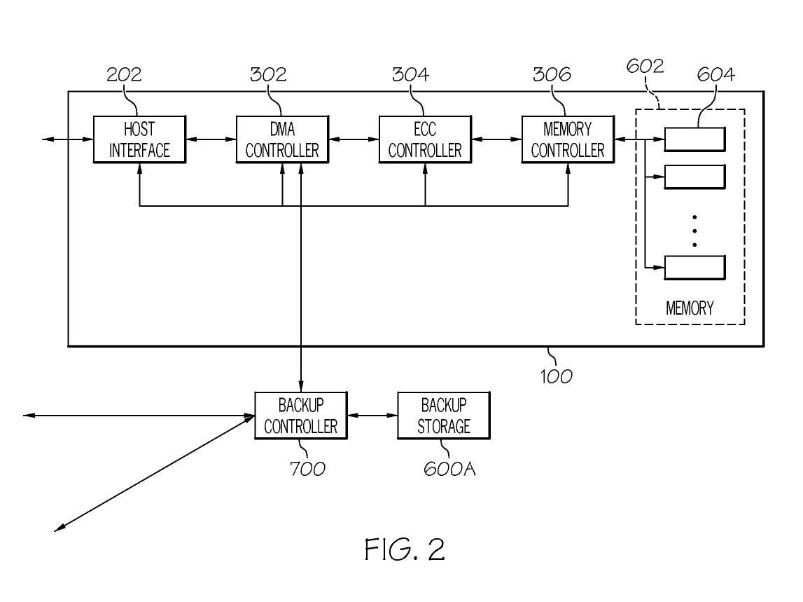

Referring now to FIG. 2, a diagram schematically illustrating a configuration of the high-speed SSD 100 is shown. As depicted, SSD/memory disk unit 100 comprises: a host interface 202 (e.g., PCI-Express host) (which can be interface 200 of FIG. 1, or a separate interface as shown); a DMA controller 302 interfacing with a backup control module 700; an ECC controller; and a memory controller 306 for controlling one or more blocks 604 of memory 602 that are used as high-speed storage.

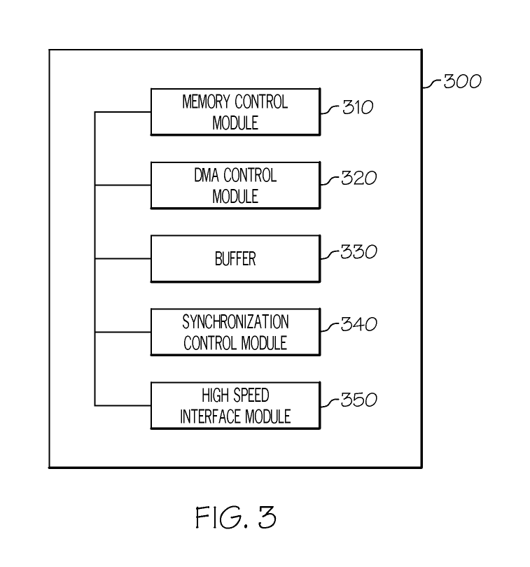

Referring now to FIG. 3, the controller unit 300 of FIG. 1 is shown as comprising: a memory control module 310 which controls data input/output of the SSD memory disk unit 100; a DMA control module 320 which controls the memory control module 310 to store the data in the SSD memory disk unit 100, or reads data from the SSD memory disk unit 100 to provide the data to the host, according to an instruction from the host received through the PCI-Express host interface unit 200; a buffer 330 which buffers data according to the control of the DMA control module 320; a synchronization control module 340 which, when receiving a data signal corresponding to the data read from the SSD memory disk unit 100 by the control of the DMA control module 320 through the DMA control module 320 and the memory control module 310, adjusts synchronization of a data signal so as to have a communication speed corresponding to a PCI-Express communications protocol to transmit the synchronized data signal to the PCI-Express host interface unit 200, and when receiving a data signal from the host through the PCI-Express host interface unit 200, adjusts synchronization of the data signal so as to have a transmission speed corresponding to a communications protocol (for example, PCI, PCI-x, or PCI-e, and the like) used by the SSD memory disk unit 100 to transmit the synchronized data signal to the SSD memory disk unit 100 through the DMA control module 320 and the memory control module 310; and a high-speed interface module 350 which processes the data transmitted/received between the synchronization control module 340 and the DMA control module 320 at high speed. Here, the high-speed interface module 350 includes a buffer having a double buffer structure and a buffer having a circular queue structure, and processes the data transmitted/received between the synchronization control module 340 and the DMA control module 320 without loss at high speed by buffering the data and adjusting data clocks

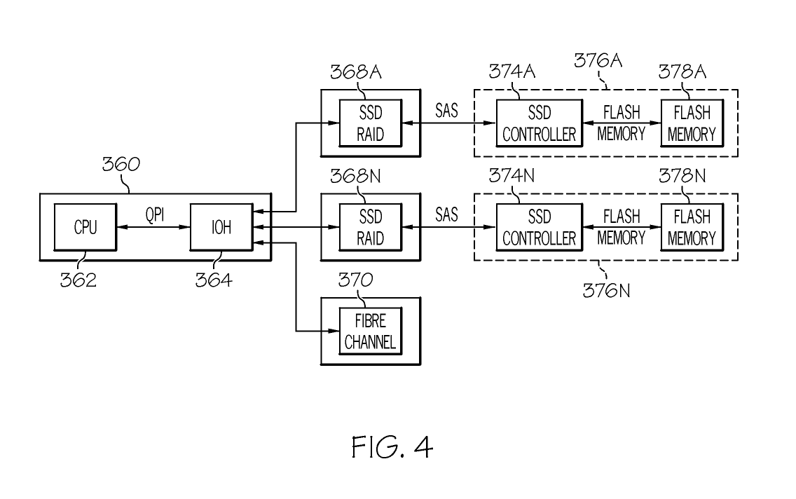

FIG. 4 is a diagram schematically illustrating the semiconductor storage device (SSD) system architecture based on flash memory. As depicted, the flash memory system comprises a set of SSD RAID controllers 368A-N coupled to system control board 360. Fibre channel chip 370 is coupled to system control board 360. Fibre channel is a technology for transmitting data between computer devices. System control board 360 generally comprises CPU 362 and IOH 364. QPI (QuickPath Interconnect)), or alternatively HyperTransport (HT), is used to connect the processor to the IOH (I/O Hub). A set of flash memory control units 376A-N is coupled to each of the set of SSD RAID controllers 368A-N, each of the set of flash memory control units comprising an SSD controller 374A-N and a set of flash memory units 378A-N.

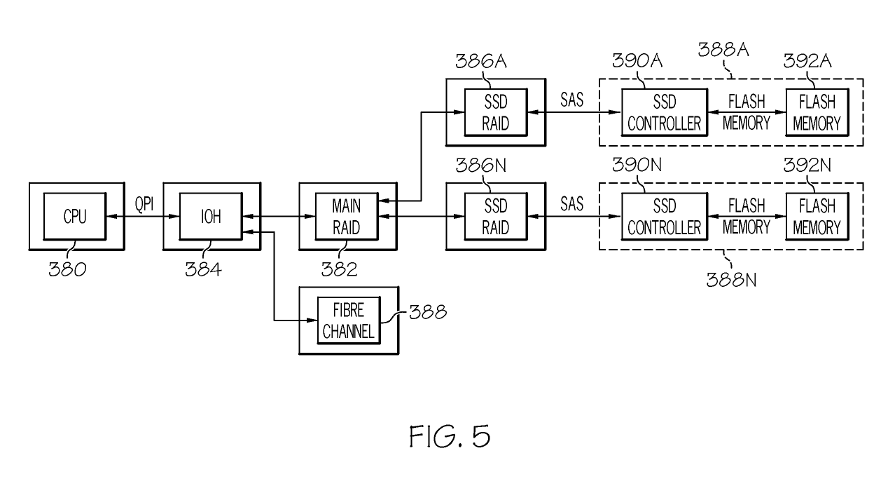

Further, FIG. 5 is a diagram schematically illustrating an alternate SSD system based on flash memory. As depicted, CPU 380 is coupled to IOH 384 using QPI. IOH 384 is coupled to main RAID 382 and fibre channel 388. Main RAID 382 is coupled to a set of SSD RAID controllers 386A-N. Each of the set of SSD RAID controllers is coupled to a flash memory control unit. For example, SSD RAID 386A is coupled to flash memory control unit 388A, SSD RAID 386N is coupled to flash memory control unit 388N, and so on. Each flash memory unit comprises a set of SSD controllers 390A-N coupled to a set of flash memory units 392A-N.

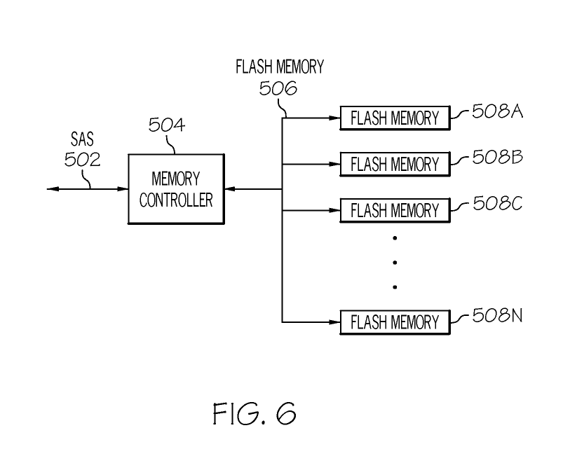

FIG. 6 shows a flash memory block diagram illustrating a detailed view of the memory components. Memory controller 504 is coupled to a storage device via SAS 502. SAS (serial attached SCSI) is a computer bus technology used for the transfer of data to storage devices. Memory controller 504 controls flash memory 506. Flash memory 506 includes a set of flash memory units 508A-N.

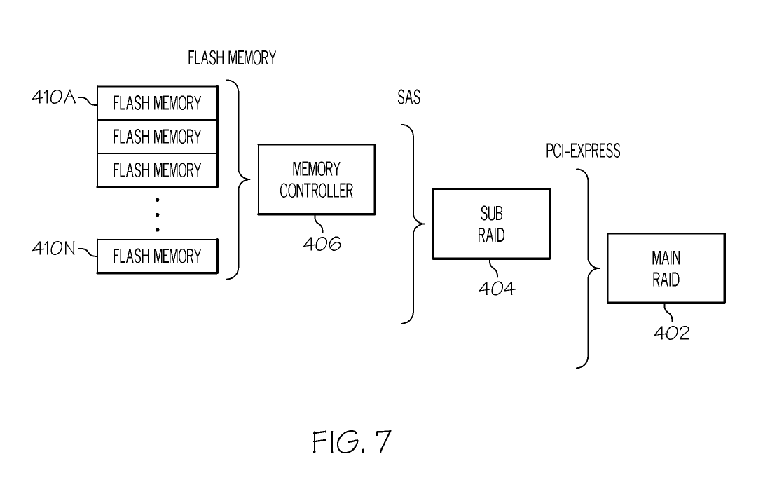

Referring now to FIG. 7, a diagram schematically illustrating the flash memory unit architecture is shown. Main RAID 402 is coupled to a set of RAID subcontrollers. An example RAID subcontroller 404 is shown. RAID subcontroller 404 is coupled to memory controller 406 (one of a set) which controls flash memory units 410A-N.

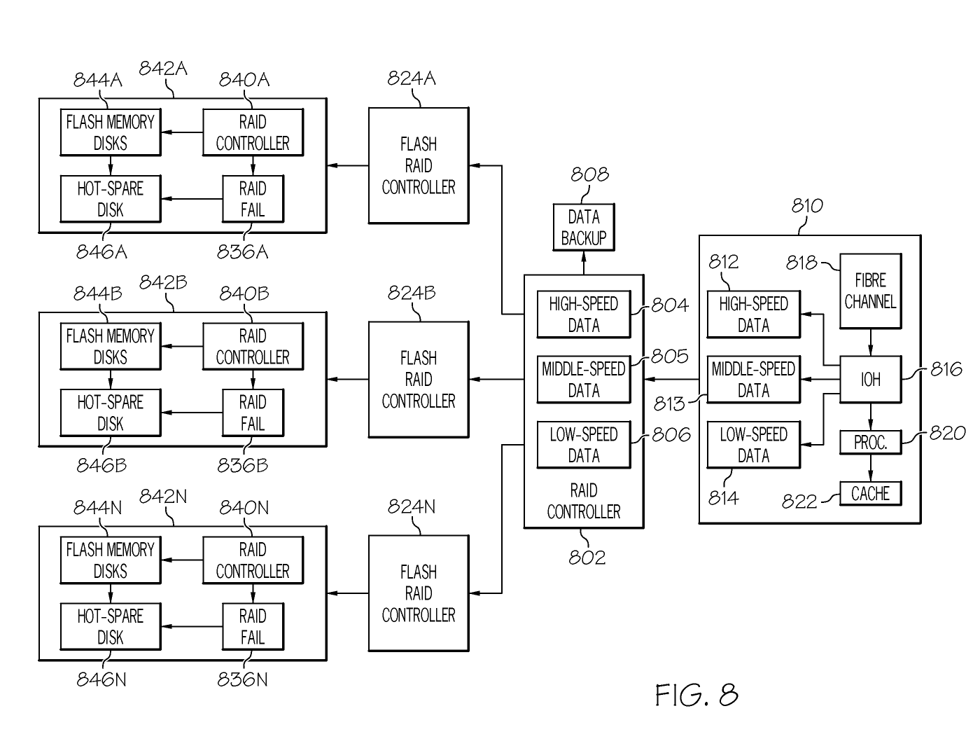

Referring now to FIG. 8, an SSD multi-level RAID system architecture based on flash memory is shown. As depicted, the architecture includes a main RAID controller 802 coupled to a system control board 810. Coupled to the main RAID controller 802 is data backup unit 808, and a set (at least one) of flash RAID controllers 824A-N. For illustrative purposes, focus is given to flash RAID controller 824A. A set (at least one) of flash RAID control blocks 842A are coupled to flash RAID controller 824A. As shown, each flash RAID control block 842A comprises: a set of flash memory disks 844A; a hot spare disk 846A coupled to the set of flash memory disks 884A; a (PCI-E to PCI-E) RAID controller 840A coupled to the set of flash memory disks 844A; and a RAID fail component 836A coupled to the RAID controller 840A. Each of the remaining flash RAID controllers 824B-N and flash RAID control blocks 842B-N making up the system architecture has a similar configuration as described above.

As further shown in FIG. 8, main RAID controller 802 comprises: a high-speed data controller 804; a middle-speed data controller 805, and a low-speed data controller 806. A data backup component 808 is shown coupled to main RAID controller 802. System control board 810 generally comprises: a chip (e.g., IOH) 816; a high-speed data controller 812 coupled to the chip 816; a middle speed data controller 813 coupled to the chip 816, a low-speed data controller 814 coupled to the chip 816; a fibre channel chip 818 coupled to the chip 816; a processor 820 coupled to the chip 816; and cache memory 822 coupled to the processor 820.

Referring back to FIG. 1, auxiliary power source unit 400 may be configured as a rechargeable battery or the like, so that it is normally charged to maintain a predetermined power using power transferred from the host through the PCI-Express host interface unit 200 and supplies the charged power to the power source control unit 500 according to the control of the power source control unit 500.

The power source control unit 500 supplies the power transferred from the host through the PCI-Express host interface unit 200 to the controller unit 300, the memory disk unit 100, the backup storage unit 600, and the backup control unit 700.

In addition, when an error occurs in a power source of the host because the power transmitted from the host through the PCI-Express host interface unit 200 is blocked, or the power transmitted from the host deviates from a threshold value, the power source control unit 500 receives power from the auxiliary power source unit 400 and supplies the power to the memory disk unit 100 through the controller unit 300.

The backup storage unit 600A-B is configured as a low-speed non-volatile storage device such as a hard disk and stores data of the memory disk unit 100.

The backup control unit 700 backs up data stored in the memory disk unit 100 in the backup storage unit 600 by controlling the data input/output of the backup storage unit 600 and backs up the data stored in the memory disk unit 100 in the backup storage unit 600 according to an instruction from the host, or when an error occurs in the power source of the host due to a deviation of the power transmitted from the host deviates from the threshold value.

While the exemplary embodiments have been shown and described, it will be understood by those skilled in the art that various changes in form and details may be made thereto without departing from the spirit and scope of this disclosure as defined by the appended claims. In addition, many modifications can be made to adapt a particular situation or material to the teachings of this disclosure without departing from the essential scope thereof. Therefore, it is intended that this disclosure not be limited to the particular exemplary embodiments disclosed as the best mode contemplated for carrying out this disclosure, but that this disclosure will include all embodiments falling within the scope of the appended claims.

The present invention supports a low-speed data processing speed for a host by adjusting synchronization of a data signal transmitted/received between the host and a memory disk during data communications between the host and the memory disk through a PCI-Express interface and simultaneously supports a high-speed data processing speed for the memory disk, thereby supporting the performance of the memory to enable high-speed data processing in an existing interface environment at the maximum.

The foregoing description of various aspects of the invention has been presented for purposes of illustration and description. It is not intended to be exhaustive or to limit the invention to the precise form disclosed and, obviously, many modifications and variations are possible. Such modifications and variations that may be apparent to a person skilled in the art are intended to be included within the scope of the invention as defined by the accompanying claims.

What is claimed is:

1. A semiconductor storage device (SSD) system architecture based on flash memory, comprising:
a set of SSD RAID controllers coupled to a system control board;
a fibre channel chip coupled to the system control board; and
a set of flash memory control units coupled to each of the set of SSD RAID controllers, each of the set of flash memory control units comprising an SSD controller and a set of flash memory units.

2. The system architecture of claim 1, the system control board comprising:
a chip; and
a processor coupled to the chip.

3. The system architecture of claim 2, wherein the chip is coupled to the processor using a QuickPath Interconnect (QPI) or HyperTransport (HT) interface.

4. The system architecture of claim 1, wherein each of the set of flash memory control units are coupled to each of the set of SSD RAID controllers using serial attached SCSI (SAS).

5. A method for providing an SSD system architecture based on flash memory, comprising:
coupling a set of SSD RAID controllers to a system control board;
coupling a fibre channel chip to the system control board; and
coupling a set of flash memory control units to each of the set of SSD RAID controllers, each of the set of flash memory control units comprising an SSD controller and a set of flash memory units.

6. The method of claim 5, the system control board comprising:
a chip; and
a processor coupled to the chip.

7. The method of claim 5, wherein the chip is coupled to the processor using a QuickPath Interconnect (QPI) or HypeTransport (HT) interface.

8. The method of claim 5, wherein each of the set of flash memory control units are coupled to each of the set of SSD RAID controllers using serial attached SCSI (SAS).

9. An SSD system architecture based on flash memory, comprising:
a chip;
a processor coupled to the chip;
a main RAID controller coupled to the chip;
a set of SSD RAID controllers coupled to the main RAID controller; and
a set of flash memory control units coupled to each of the set of SSD RAID controllers, each of the set of flash memory control units comprising an SSD controller and a set of flash memory units.

10. The system architecture of claim 9, wherein the chip is coupled to the processor using a QPI or HT interface.

11. system architecture of claim 9, wherein each of the set of flash memory control units are coupled to each of the set of SSD RAID controllers using serial attached SCSI (SAS).

12. A method for providing an SSD system architecture based on flash, comprising:
coupling a processor coupled to a chip;
coupling a main RAID controller coupled to the chip;
coupling a set of SSD RAID controllers to the main RAID controller; and
coupling a set of flash memory control units to each of the set of SSD RAID controllers, each of the set of flash memory control units comprising an SSD controller and a set of flash memory units.

13. The method of claim 12, wherein the chip is coupled to the processor using a QPI or HT interface.

14. The method of claim 12, wherein each of the set of flash memory control units are coupled to each of the set of SSD RAID controllers using serial attached SCSI (SAS).

15. An SSD multi-level RAID system architecture based on flash memory, comprising:
a main RAID controller coupled to a system control board;
a set of flash memory RAID subcontrollers coupled to the main RAID controller; and
a set of flash memory RAID control blocks coupled to each of the set of flash memory RAID subcontrollers, each of the set of flash memory RAID control blocks comprising a set of flash memory units.

16. The system architecture of claim 15, the system control board comprising:
a chip;
a high-speed data controller coupled to the chip;
a low-speed data controller coupled to the chip;
a fibre channel chip coupled to the chip;
a processor coupled to the chip; and
cache memory coupled to the processor.

17. The system architecture of claim 15, the main RAID controller comprising:
a high-speed data controller; and
a low-speed data controller.

18. The system architecture of claim 15, each of the set of flash memory RAID control blocks further comprising:
a hot spare disk coupled to the set of flash memory units;
a RAID controller coupled to the set of flash memory units;
a RAID fail component coupled to the RAID controller; and
a data backup component coupled to the RAID controller.

19. The system architecture of claim 18, the RAID controller comprising a PCI-Express RAID controller.

20. An SSD multi-level RAID system architecture based on flash memory, comprising:
a main RAID controller coupled to a system control board;
a set of flash memory RAID subcontrollers coupled to the main RAID controller; and
a set of flash memory RAID control blocks coupled to each of the set of flash memory RAID subcontrollers, each of the set of flash memory RAID control blocks comprising a set of flash memory units and a PCI-Express RAID controller.

21. The system architecture of claim 20, the system control board comprising:
a chip;
a high-speed data controller coupled to the chip;
a low-speed data controller coupled to the chip;
a fibre channel chip coupled to the chip;
a processor coupled to the chip; and
cache memory coupled to the processor.

22. The system architecture of claim 20, the main RAID controller comprising:
a high-speed data controller; and
a low-speed data controller.

23. The system architecture of claim 20, each of the set of flash memory RAID control blocks further comprising:
a hot spare disk coupled to the set of flash memory units;
a RAID fail component coupled to the RAID controller; and
a data backup component coupled to the RAID controller.

24. A method for providing an SSD multi-level RAID system architecture based on flash memory, comprising:
coupling a main RAID controller to a system control board;
coupling a set of flash memory RAID subcontrollers to the main RAID controller; and
coupling a set of flash memory RAID control blocks to each of the set of flash memory RAID subcontrollers, each of the set of flash memory RAID control blocks comprising a set of flash memory units.

25. The method of claim 24, the system control board comprising:
a chip;
a high-speed data controller coupled to the chip;
a low-speed data controller coupled to the chip;
a fibre channel chip coupled to the chip;
a processor coupled to the chip; and
cache memory coupled to the processor.

26. The method of claim 24, the main RAID controller comprising:
a high-speed data controller; and
a low-speed data controller.

27. The method of claim 24, each of the set of flash memory RAID control blocks further comprising:
a hot spare disk coupled to the set of flash memory units;
a PCI-Express RAID controller coupled to the set of flash memory units;
a RAID fail component coupled to the RAID controller; and
a data backup component coupled to the RAID controller.
